(19) United States
(12) Patent Application Publication
(10) Pub. No.: US 2003/0070317 A1
(43) Pub. Date: Apr. 17, 2003

(54) Apparatus and method for removing solvent from particulate

(76) Inventors: George E. Anderson, Champlin, MN (US); Richard W. Ozer, Golden Valley, MN (US)

Correspondence Address: NAWROCKI, ROONEY & SIVERTSON, P.A., Suite 401, Broadway Place East, 3433 Broadway Street N.E., Minneapolis, MN, 55413, US

(21) Appl. No.: 09/978,426

(22) Filed: Oct. 15, 2001

(51) Int. Cl. B08B 5/00; F26B 3/08

(52) U.S. Cl. 34/359; 134/21; 134/10; 134/25.1

(57) ABSTRACT

An apparatus for removing a solvent from particulate material has a feeding device, a desolventizer, a solvent stripping device, a recirculation mechanism, and a sealing mechanism. The desolventizer has an inlet attached to the feeding device and an outlet structure. The solvent stripping device has a particulate treatment housing with a first and a second end and a conveying mechanism therein. The solvent stripping device also has a particulate inlet, an inert gas inlet, and a particulate outlet. The particulate inlet is located on the lower end and is connected to the desolventizer outlet. The recirculation mechanism removes solvent from an inert gas-solvent mixture. The sealing mechanism is connected between the outlet structure of the desolventizer and the inlet of the solvent stripping device. The sealing mechanism is constructed and arranged to prevent the movement of un-entrained solvent from entering the solvent stripping device.

### BACKGROUND OF THE INVENTION

The present invention relates generally to the field of solid particulate processing. In particular, the present invention relates to an apparatus for the treatment of particulate material contaminated with a solvent or other fluid.

The use of solvents and other fluids such as hexane, heptane, alcohols, water, and other liquids in processing material is generally known. Within these general processes there are many known specific processes in which a solvent comes into contact with, and contaminates, a material.

By way of example, and for the purpose of illustration, the invention will be described herein in connection with the removal of a volatile material from the meal created from oil-bearing seeds. Solvent is often introduced during the extraction of oil from seeds.

Traditionally, the seeds are processed into flakes or other particulate forms. This particulate seed material is referred to as seed meal. The seed meal is typically contacted by a volatile material, usually hexane, or a similar solvent. The contact of the seed meal with the solvent extracts the oil from the seed meal, however, some solvent is left in the oil and in the meal. Typically, once the extraction process has been completed, both the oil and the seed meal will require desolventizing and/or deodorizing before they can be processed further.

Usually a desolventizer is used to remove the bulk of the solvent entrained in the meal, however, small amounts of solvent are left behind by these devices and may require additional stripping in order to make the meal substantially free of solvents.

The goals of a solvent stripping device are generally focused on; removing the remaining amount of solvent to make the meal flakes ready for further processing, preventing the flakes of meal from being degraded through excessive impact with surfaces within the device, avoiding overheating of the device, and eliminating significant cooking of the meal.

An apparatus and method should be designed to provide removal of the remainder of solvent or other fluid from the particulate material. Further, the device should not cause degradation of the particulate. The device should also provide adequate heating of the meal to accomplish the removal of the solvent, while not heating the meal to a point where it becomes cooked. Additionally, the device should make efficient use of the amount of inert gas used to remove solvent and should be designed to keep un-entrained solvent from passing from the desolventizer into the solvent stripper.

The present invention addresses these needs, as well as other problems associated with existing methods and apparatus for removing volatile materials from a liquid.

### SUMMARY OF THE INVENTION

The present invention relates to an apparatus for the removal of a solvent or other fluid from a particulate material through use of a solvent stripping device. The apparatus includes a feeding device, a desolventizer, a solvent stripping device, and a sealing means.

The feeding device feeds the solvent laden particulate into the desolventizer. Typically, the feeding device is comprised of an inlet, a reservoir, and an outlet.

The desolventizer removes the bulk of the solvent or fluid entrained within the seed meal. Desolventizers generally employ heated steam to extract the majority of solvent or fluid from the particulate as it passes through the desolventizer. Generally, the particulate material passes through the desolventizer by a conveyance means.

For example, in a down draft desolventizer, the particulate is conveyed by a mechanical chain driven conveyor system contained within a housing. The desolventizers pre-treat the particulate so it is ready for the stripping of the remaining solvent by a solvent stripping device.

The solvent stripping device is comprised of a particulate treatment housing having a conveying means therein and a recirculation means for removing the solvent from the housing. The housing has a particulate inlet, a particulate outlet, and an inert gas inlet. The inert gas within the particulate treatment housing acts to extract the solvent from the particulate. The inert gas is then removed from the housing by the recirculation means.

A sealing means is located between the desolventizer and the solvent stripping device to keep un-entrained solvent, within the desolventizer, from passing into the solvent stripping device.

The present invention also defines a method for removing solvent from a particulate material that involves the following steps. A supply of particulate material, contaminated with solvent, is provided to be treated by the apparatus. The particulate material is conveyed on a conveying means within a housing structure having an interior.

A vacuum is applied to the interior of the housing and inert gas is introduced to the particulate material. The inert gas acts to remove at least some of the solvent from the contaminated particulate, thereby forming a gas-solvent mixture. The gas-solvent mixture is removed from the interior of the housing and at least a portion of the solvent is removed from the gas-solvent mixture leaving recycled inert gas.

The recycled inert gas is then re-circulated into the interior of the housing. The recycled inert gas is once again contacted with the particulate, thereby removing solvent from the particulate and forming a gas-solvent mixture and creating treated particulate. The gas-solvent mixture is then removed from the interior of the housing and the treated particulate material is removed from the housing.

The above mentioned benefits and other benefits of the invention will become clear from the following description by reference to the accompanying drawings.

### DESCRIPTION OF THE DRAWINGS

FIG. 1 is a representation of the elements of the preferred embodiment of the system of the invention;

FIG. 2 is a cutaway side perspective view of the preferred embodiment of the separation device;

FIG. 3 is an enlarged cutaway sectional view of the support structure of the conveying means and the baffle structure of the device of FIG. 2;

FIG. 4 is an enlarged cutaway sectional view at 3-3 of the first end of the particulate treatment housing of the device of FIG. 2;

FIG. 5 is an enlarged cutaway sectional view of the second end of the particulate treatment housing of the device of FIG. 2; and

FIG. 6 is an alternate representation of the elements of the preferred embodiment of the system of the invention;

### DESCRIPTION OF THE PREFERRED EMBODIMENT

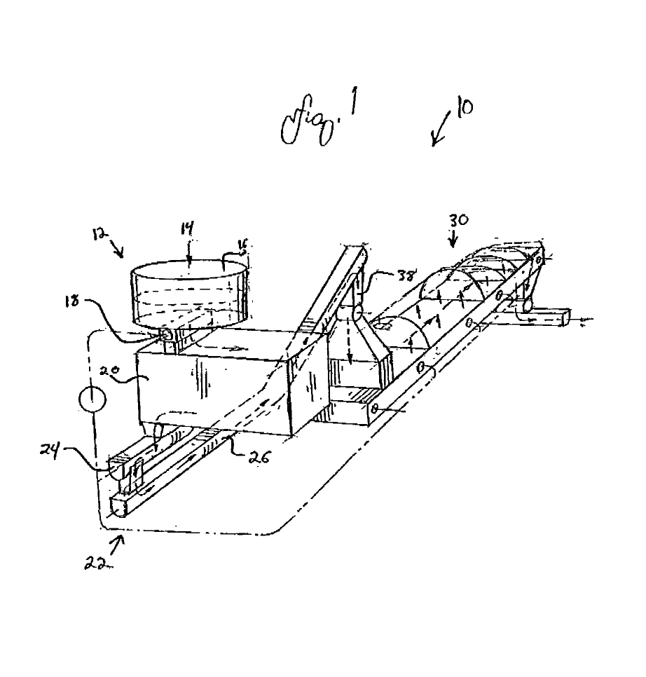

The present invention relates to an apparatus for the removal of a solvent or other fluid from a particulate material through use of a solvent stripping device. The term solvent, as used hereinafter, generally describes solvents and other fluids that are removed from particulate material. The apparatus, as shown in FIG. 1, is constructed in accordance with the present invention. As shown, the apparatus 10 includes a feeding device 12, a desolventizer 20, a solvent stripping device 30, and a sealing means.

The feeding device is used to feed the solvent laden particulate into the desolventizer. In the embodiment shown, the feeding device 12 is comprised of an inlet 14, a reservoir 16, and an outlet 18. The outlet of the feeding device 16 is connected to a desolventizer 20.

The desolventizer 20 is utilized to remove the bulk of the solvent or fluid entrained within the particulate. One of three types of desolventizers is typically used for treatment of particulate material; namely, a flash desolventizer, a vapor desolventizer, or a down draft desolventizer. The apparatus 10 may be comprised of any desolventizer and the solvent stripping device may be used with any of these desolventizers.

Once the particulate material enters the desolventizer 20, the particulate is moved through the desolventizer wherein a substantial amount of solvent is removed. A down draft style desolventizer that may be used with the present invention is disclosed in U.S. Pat. No. 5,630,911, which is incorporated herein by reference. The down draft style desolventizer, moves particulate material through the desolventizer on a series of conveyors stacked on top of each other. The particulate enters at the top of the desolventizer and is conveyed across the top conveyor until it reaches the end where the particulate then falls to the next highest conveyor. This process continues until the particulate runs off the end of the bottom conveyor and into an outlet. The device pre-treats the particulate so it is ready for the stripping of the remaining solvent. The particulate is then transferred from the desolventizer to the solvent stripping device.

A sealing means 22 is located between the desolventizer 20 and the solvent stripping device 30 to keep un-entrained solvent, within the desolventizer 20, from passing into the solvent stripping device 30. One such sealing means is shown in FIG. 1.

As shown, a screw plug 24 is arranged at the outlet of the desolventizer 20. The screw plug 24 is connected to a conveyor 26 that is sloped upward toward the particulate inlet 38 of solvent stripper 30. The screw plug 24 acts to keep the majority of un-entrained solvent from passing from the desolventizer 20 to the solvent stripper 30. A sloped conveyor design, as shown, may also be provided which acts to further inhibit the movement of the un-entrained solvent. Additionally, a supply of inert gas may be injected at the end of the conveyor 26 to form a curtain of gas to further inhibit the movement of the un-entrained solvent.

Another type of sealing means is shown in FIG. 6. In this embodiment, the conveyor 26 is not inclined and the sealing means is a shroud 28 that can be hung at the outlet of the desolventizer 20, or at the beginning of the solvent stripper 30, and is arranged to hang over the particulate as it is conveyed out of the desolventizer. The shroud 28 is preferably designed to allow minimal clearance for the particulate to pass beneath it, thereby allowing little room for the un-entrained solvent to pass under the shroud 28. By keeping the un-entrained solvent out of the particulate treatment housing, the inert gas only removes solvent entrained within the particulate, thereby maximizing the efficiency of the solvent stripping device 30.

The solvent stripping device 30 is comprised of a particulate treatment housing 32 having a conveying means 34 therein and a recirculation means 36 for removing the solvent from the housing.

The particulate treatment housing 32 has a first end and a second end, a particulate inlet 38 that receives particulate from the desolventizer, a particulate outlet 40 for sending the treated particulate out of the housing after the remaining solvent has been removed, and an inert gas inlet 42 that injects gas into the housing.

Solvent laden particulate is fed from the desolventizer 20 into the particulate inlet 38 of the solvent stripping device 30. Preferably, the particulate inlet 38 is positioned near the first end of the particulate treatment housing 32 and arranged above the conveying means 34, so that the particulate begins moving through the housing. The conveying means 34, housed within the particulate treatment housing 32, may be any suitable conveying means known in the art.

For example, as shown in FIG. 6, a screw conveyor 44 may be used. As shown, the conveyor screw should preferably have a uniform diameter blade as it ribbons down the shaft. If a screw mechanism is used, the housing 32 should be circular in diameter and preferably sized to move the particulate through the housing 32 cleanly, without getting any particulate caught between the end of the blade and the housing surface.

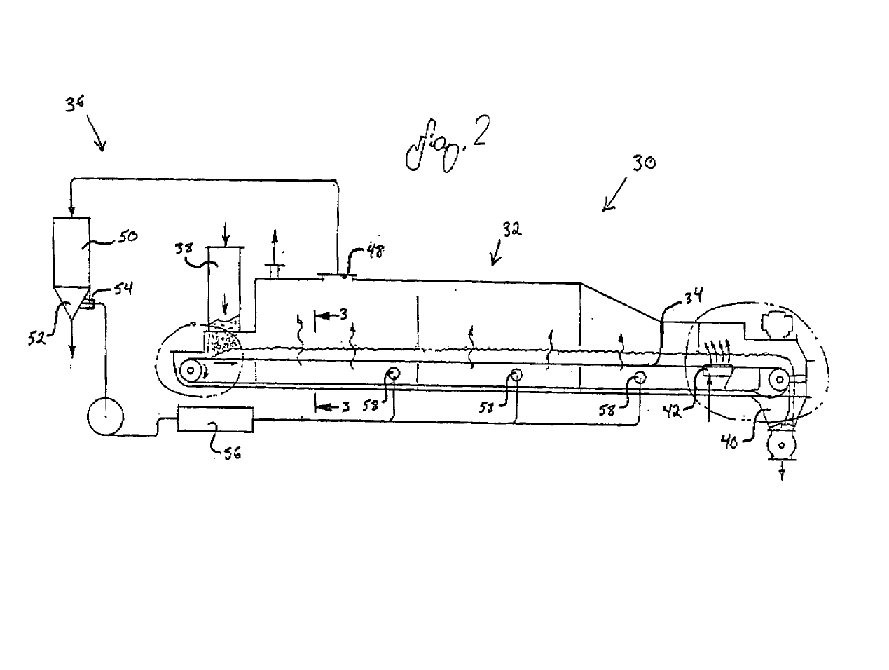

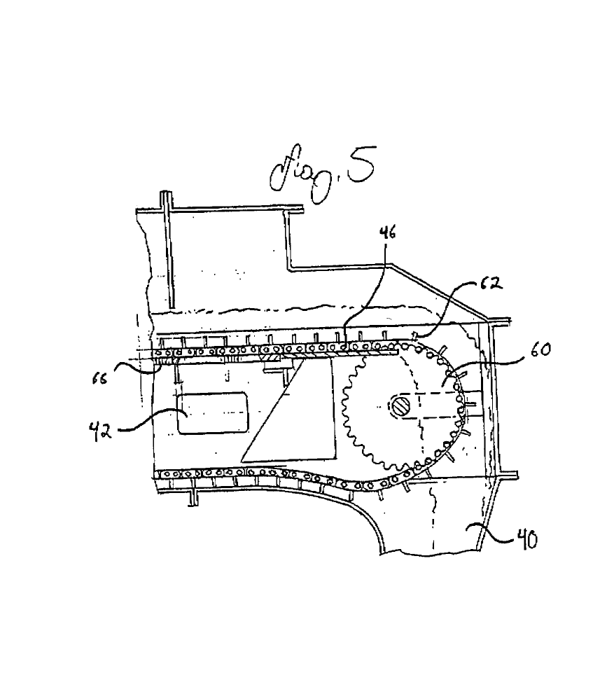

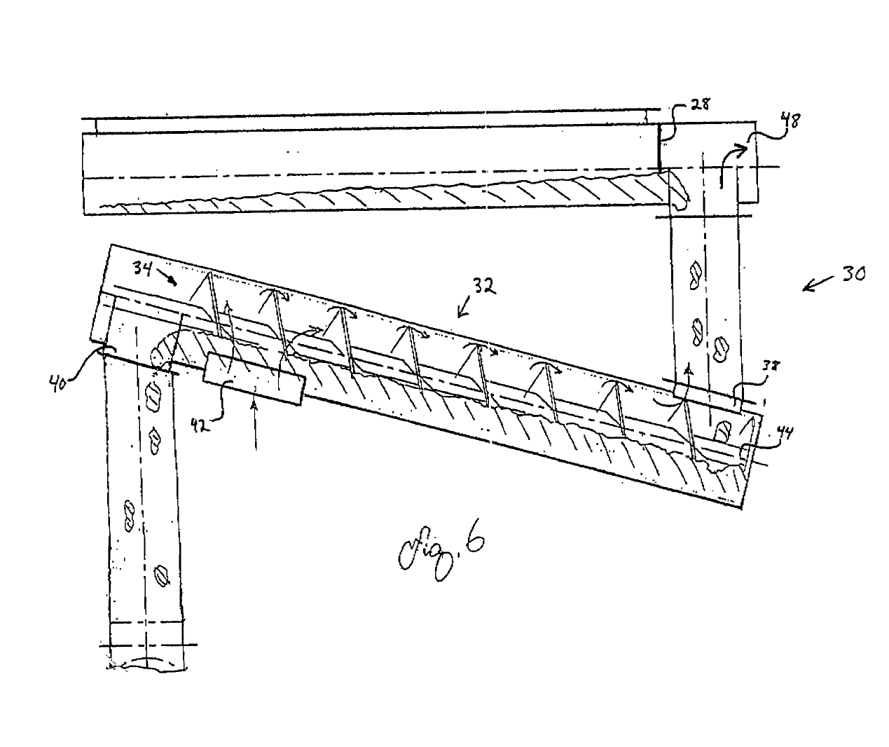

Another example is shown in FIGS. 2 through 5, wherein a belt or chain driven conveyor 46 is utilized. In this embodiment, the chain driven conveyor 46 has a generally flat surface with a plurality of flights 62 extending generally perpendicular to the surface of the conveyor and extending across the surface of the conveyor. The flights 62 may be used to provide a means of pushing the particulate along the conveyor.

The conveyor surface is preferably supported along its width and its length by any means known in the art. In this embodiment, the conveyor surface is supported by a plurality of rigid sections having baffles 66 formed thereon for the direction of inert gas. The baffles 66 are angled so that they direct the flow of inert gas toward the first end of the housing 32. This encourages the gas-solvent mixture to enter the gas-solvent inlet 48 and aids in keeping solvent from exiting the housing 32 through the particulate outlet 40. The rigid sections may or may not have baffles and may be held in place by any means known in the art.

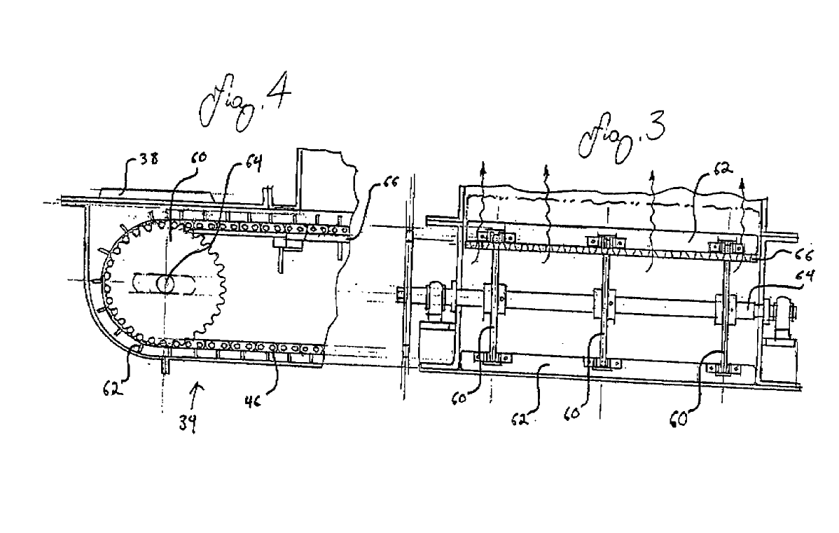

The conveyor is driven, and additionally supported, by a plurality of gears 60 that are rotated on a plurality of axles 64. Preferably, there is an axle at each end of the conveyor 46 and each axle should have at least one gear for driving the conveyor. As shown in FIG. 3, this embodiment provides three gears on each axle.

The particulate outlet 40 is preferably located at the second end of the housing 32, as shown in FIG. 3. Preferably, the particulate treatment housing 32 is angled upward, having the first end lower than the second end, as shown in FIG. 6. This configuration acts to inhibit any un-entrained solvent from exiting the particulate treatment housing 32 through the particulate outlet 40.

The inert gas inlet 42 injects inert gas into the housing 32. Preferably, the inert gas inlet 42 is positioned near the second end of the housing between the center of the housing 32 and the particulate outlet 40. Preferably, if the inert gas inlet is positioned at this end of the housing, the particulate is generally free of solvent at this point and instead of removing solvent from the particulate, the inert gas forms a gas curtain to restrict the flow of un-entrained solvent from moving out of the solvent stripping device through the particulate outlet. Furthermore, some of the inert gas is then drawn into the gas-solvent inlet and replenishes the supply of gas being re-circulated through the recycled gas outlet(s) 58.

When the inert gas contacts the particulate, some of the solvent entrained within the particulate is extracted and forms a gas-solvent mixture. The recirculation means 36 removes the majority of the solvent from the inert gas and recycles the gas back into the housing 32, where it removes more solvent.

The recirculation means may be any suitable system for the removal of volatile material from an inert gas. For example, as shown in FIG. 2, the recirculation means 36 may be comprised of at least one gas-solvent inlet 48, a condenser 50 having a solvent outlet 52 and at least one recycled gas outlet 54, a heater 56, and a recycled inert gas outlet 58. The gas-solvent inlet 48 connects the interior of the particulate treatment housing 32 with the recirculation means 36 and is preferably located above the conveying means 34 and near the particulate inlet 38. The recirculation means preferably produces a vacuum to draw the gas-solvent mixture into the gas solvent inlet(s) 48. Using this arrangement, the gas-solvent mixture is drawn away from the particulate outlet 40, thereby aiding in keeping the un-entrained solvent from exiting the housing through the particulate outlet 40.

Once inside the condenser 50, the mixture is cooled. The cooling action separates most of the solvent from the gas. The separated solvent then exits the apparatus through the solvent outlet 52 while the recycled inert gas exits the condenser 50 through the recycled gas outlet 54.

The recycled gas then travels through a heater 56 where it is heated to a suitable temperature to provide a suitable carrier for the solvent. The recycled gas is then re-injected into the housing 32 through at least one recycled gas outlet 58.

Preferably, the recycled gas outlets 58 are aligned along the side of the housing 32 and are staggered between the inert gas inlet 42 and the particulate inlet 40. In this arrangement, the recycled inert gas contacts the particulate in several locations as the particulate is conveyed through the housing 32. Once the recycled gas contacts the particulate, it again combines with solvent to form a gas-solvent mixture. The gas-solvent mixture is then drawn out of the housing 32 through the gas-solvent inlet 48 and into the recirculation means 36, where the solvent is removed and the recycled gas is, once again, heated and injected into the particulate treatment housing 32. The recycling process may be repeated several times while the particulate is traveling on the conveyor or may be done continuously, thereby allowing a continuous flow of gas to contact the particulate material to be cleaned.

The method for removing solvent from a particulate material involves the following steps. A supply of particulate material, contaminated with solvent, is provided to be treated by the apparatus 10. The particulate material is conveyed on a conveying means 34 within a housing structure 32 having an interior.

A vacuum is applied to the interior of the housing 32 and inert gas is introduced to the particulate material. The inert gas acts to remove at least some of the solvent from the contaminated particulate, thereby forming a gas-solvent mixture. The gas-solvent mixture is removed from the interior of the housing 32 and at least a portion of the solvent is removed from the gas-solvent mixture to form recycled inert gas.

The recycled inert gas is then re-circulated into the interior of the housing. The recycled inert gas is once again contacted with the particulate, thereby removing solvent from the particulate and forming a gas-solvent mixture and creating treated particulate. The gas-solvent mixture is then removed from the interior of the housing and the treated particulate material is removed from the housing.

Since many possible embodiments may be made of the present invention without departing from the scope thereof, it is to be understood that all matter herein set forth or shown in the accompanying drawings is to be interpreted in the illustrative and not a limiting sense.

That which is claimed is:

1. An apparatus for removing a solvent from particulate material comprising:
a feeding device;
a desolventizer having an inlet attached to said feeding device and an outlet structure;
a solvent stripping device comprising a particulate treatment housing having a first and a second end and a conveying means therein, a particulate inlet, an inert gas inlet, and a particulate outlet, said particulate inlet located on said first end and connected to said desolventizer outlet;
a recirculation means constructed and arranged to remove solvent from said particulate treatment housing and recycle inert gas to be re-circulated into said particulate treatment housing; and
a sealing means connected between said outlet structure of said desolventizer and said solvent stripping device, said sealing means being constructed and arranged to prevent the movement of un-entrained solvent from entering the solvent stripping device.

2. An apparatus according to claim 1, wherein said feeding device is comprised of an inlet, a reservoir, and an elongated-slot outlet structure, said outlet structure attached to said desolventizer inlet.

3. An apparatus according to claim 1, wherein said recirculation means is comprised of a solvent removal device having a gas-solvent inlet, a solvent outlet, and a recycled inert gas outlet; said gas-solvent inlet and said recycled inert gas outlet being connected to said particulate treatment housing.

4. An apparatus according to claim 1, wherein said particulate outlet and said inert gas inlet are located on said second end of said particulate treatment housing.

5. An apparatus according to claim 1, wherein said sealing device is a plug screw mechanism.

6. An apparatus according to claim 1, wherein said sealing device is a shroud.

7. An apparatus according to claim 1, wherein said sealing device is comprised of a plug screw mechanism connected to said desolventizer outlet, a conveyor means, and a shroud; said plug screw mechanism constructed and arranged to deliver particulate material from said desolventizer to one end of said conveyor means, said shroud being located in proximity to the other end of said conveyor means.

8. An apparatus according to claim 1, wherein said particulate treatment housing has a baffle structure therein.

9. A method for removing solvent from particulate material, comprising the steps of:
providing a supply of particulate material, contaminated with solvent, to be treated;
conveying said particulate material on a conveying means within a housing structure having an interior;
applying a vacuum to the interior of said housing;
introducing an inert gas to said particulate material;
removing at least some of said solvent from said contaminated particulate, thereby forming a gas-solvent mixture;
removing the gas-solvent mixture from the interior of said housing;
removing at least a portion of the solvent from the gas-solvent mixture to form recycled inert gas;
recirculating the recycled inert gas into the interior of said housing;
contacting the recycled inert gas with the particulate;
removing solvent from the particulate, thereby forming a gas-solvent mixture and treated particulate;
removing the gas-solvent mixture from the interior of said housing; and
removing the treated particulate material from said housing.

10. A method according to claim 9, wherein the inert gas is continuously introduced to the particulate material.

11. A method according to claim 9, wherein the gas-solvent mixture is continuously recycled and re-circulated.

12. A solvent stripping device for the stripping of solvent from particulate material comprising:
a particulate treatment housing having an interior, a first end, a second end, a particulate inlet, an inert gas inlet, at least one recirculation inlet, at least one recirculation outlet, and a particulate outlet;
a recirculation means having at least one inlet and at least one outlet, each connected to said particulate treatment housing, being constructed and arranged to re-circulate inert gas into and out of said housing; and
a conveying means constructed and arranged within the interior of said housing.

13. A solvent stripping device according to claim 12, wherein said conveying means is a screw conveyor.

14. A solvent stripping device according to claim 12, wherein said conveying means is a chain driven conveyor surface.

15. An apparatus according to claim 12, wherein said particulate treatment housing has a baffle structure therein.

16. A solvent stripping device according to claim 15, wherein said baffle structure contains a plurality of baffles each having top and bottom ends, said baffles being generally angled with the top end of each baffle closer to the first end of the housing than the second end of the baffle.

17. A solvent stripping device according to claim 12, wherein said inert gas inlet and said particulate outlet are located on said first end of said housing.

18. A solvent stripping device according to claim 12, wherein said particulate inlet is located on said second end of said housing.

19. A solvent stripping device according to claim 12, wherein said housing is sloped upward at an angle of approximately 5 degrees from first end to second end.

20. A solvent stripping device according to claim 12, wherein said recirculation means further comprises a solvent removal device having an inert gas-solvent inlet, a solvent outlet, and an inert gas outlet; said inert gas-solvent inlet connected to said recirculation outlet and said inert gas outlet connected to said recirculation inlet.

21. A solvent stripping device according to claim 12, wherein said solvent removal device is further comprised of a condensing means and a heating means.
